(19) United States
(12) Patent Application Publication
(10) Pub. No.: US 2009/0057264 A1
(43) Pub. Date: Mar. 5, 2009

(54) HIGH THROUGHPUT LOW TOPOGRAPHY COPPER CMP PROCESS

(75) Inventors: DAVID H. MAI, Palo Alto, CA (US); Stephen Jew, San Jose, CA (US); Shih-Haur Walters Shen, Hsin-Chu (TW); Zhihong Wang, Santa Clara, CA (US)

Correspondence Address: PATTERSON & SHERIDAN, LLP - - APPM/TX, 3040 POST OAK BOULEVARD, SUITE 1500, HOUSTON, TX, 77056, US

(73) Assignee: Applied Materials, Inc.

(21) Appl. No.: 12/201,370

(22) Filed: Aug. 29, 2008

Related U.S. Application Data
(60) Provisional application No. 60/968,845, filed on Aug. 29, 2007.

(51) Int. Cl. H01B 13/00

(52) U.S. Cl. 216/13

(57) ABSTRACT

Embodiments described herein generally provide a method for processing metals disposed on a substrate in a chemical mechanical polishing system. The apparatus advantageously facilitates efficient bulk and residual conductive material removal from a substrate. In one embodiment a method for chemical mechanical polishing (CMP) of a conductive material disposed on a substrate is provided. A substrate comprising a conductive material disposed over an underlying barrier material is positioned on a first platen containing a first polishing pad. The substrate is polished on a first platen to remove a bulk portion of the conductive material. A rate quench process is performed in order to reduce a metal ion concentration in the polishing slurry. The substrate is polished on the first platen to breakthrough the conductive material exposing a portion of the underlying barrier material.

### CROSS-REFERENCE TO RELATED APPLICATIONS

This application claims benefit of U.S. Provisional Patent Application Ser. No. 60/968,845, filed Aug. 29, 2007, which is herein incorporated by reference.

### BACKGROUND OF THE INVENTION

1. Field of the Invention

Embodiments described herein generally relate to a method for chemical mechanical polishing.

2. Description of the Related Art

Chemical mechanical planarization, or chemical mechanical polishing (CMP), is a common technique used to planarize substrates. CMP utilizes two modes to planarize substrates. One mode is a chemical reaction using a chemical composition, typically a slurry or other fluid medium, for removal of material from substrates, and the other is mechanical force. In conventional CMP techniques, a substrate carrier or polishing head is mounted on a carrier assembly and positioned in contact with a polishing pad in a CMP apparatus. The carrier assembly provides a controllable pressure to the substrate urging the substrate against the polishing pad. The pad is moved relative to the substrate by an external driving force. Thus, the CMP apparatus affects a polishing or rubbing movement between the substrate surface and the polishing pad, while dispensing a polishing composition to encompass both chemical and mechanical activities.

Increased substrate throughput using CMP is highly desirable. However attempts to increase substrate throughput by increasing the pressure applied to the substrate surface can lead to a decrease in planarization efficiency and a corresponding increase in hollow metal and corrosion defects. Planarization efficiency is defined as a reduction of the step height of a deposited material. In the CMP process, planarization efficiency is a function of both pressure and platen speed applied between the substrate surface polishing pad. The higher the pressure, the higher the polishing rate and the poorer the planarization efficiency. Whereas a lower polishing rate leads to better planarization efficiency but also leads to a decrease in throughput.

Thus, there is a need for an improved method and apparatus for chemical mechanical processing of metal and barrier materials which increases substrate throughput while maintaining improved planarization efficiency.

### SUMMARY OF THE INVENTION

Embodiments described herein generally provide a method for processing conductive materials disposed on a substrate in a chemical mechanical polishing system. In one embodiment a method for chemical mechanical polishing (CMP) of a conductive material disposed on a substrate is provided. A substrate comprising a conductive material disposed over an underlying barrier material is positioned on a first platen containing a first polishing pad. The substrate is polished on the first platen to remove a first portion of the bulk conductive material. A rate quench process is performed in order to reduce a metal ion concentration in the polishing slurry. The substrate is polished on the first platen to remove a second portion of the bulk material to breakthrough the conductive material exposing a portion of the underlying barrier material.

In another embodiment a method for chemical mechanical polishing of a conductive material on a substrate is provided. A substrate comprising a conductive material disposed over an underlying barrier material is positioned on a first platen containing a first polishing pad in a polishing slurry. The substrate is polished on the first platen to remove a first portion of the bulk conductive material. An endpoint for the polishing the substrate on a first platen to remove a first portion of the bulk conductive material is determined. A rate quench process is performed in order to reduce metal ion concentration in the polishing slurry. The substrate is polished on the first platen to remove a second portion of the bulk conductive material to breakthrough the conductive material exposing a portion of the underlying barrier material.

In yet another embodiment, a method for chemical mechanical polishing of a conductive material disposed on a substrate is provided. A substrate comprising copper material disposed over an underlying barrier material is positioned on a first platen containing a polishing a pad in a polishing composition comprising a corrosion inhibitor. The substrate is contacted with the polishing pad. The substrate is polished with the polishing pad to remove bulk copper material. A first endpoint of the bulk copper material removal is detected. The polishing pad is rinsed with a rinse solution. The substrate is polished with the polishing pad to breakthrough the copper material exposing a portion of the underlying barrier material. The substrate is polished on a second platen to remove residual copper material

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a plan view of a chemical mechanical planarizing system;

FIG. 2 is a plan view of a processing station of FIG. 1;

FIG. 3 is a flow diagram of one embodiment of a method for chemical mechanical polishing a conductive material;

FIG. 4A is a plot depicting the thickness of a copper layer (Å) versus the polish time (seconds) for platen 1;

FIG. 4B is a plot depicting the thickness of a copper layer (Å) versus the polish time (seconds) for platen 2;

FIG. 5 is a plot comparing the polish time for standard and high throughput copper processes; and

FIG. 6 is a plot comparing the topography performance for the standard and high throughput copper processes.

To facilitate understanding, identical reference numerals have been used, wherever possible, to designate identical elements that are common to the figures. It is contemplated that elements and/or process steps of one embodiment may be beneficially incorporated in other embodiments without additional recitation.

### DETAILED DESCRIPTION

Embodiments described herein generally provide a method for processing conductive materials disposed on a substrate in a chemical mechanical processing system. On polishing platforms with two platens dedicated for copper clearing during chemical mechanical planarization (CMP) of copper, traditionally the first platen has been used for bulk copper removal down to aproximately 2000 Å copper remaining with no copper breakthrough to expose the underlying barrier material and the second platen is used for copper clearing and copper field residue removal. The second platen requires a “soft landing” in order to produce uniform and low topography in terms of dishing and erosion which will lead to good line resistance (Rs) uniformity. With the lower copper removal rate and overpolish time necessary to ensure field copper residue removal, the second platen for copper CMP is not only the most important in determining topography but is also usually a throughput bottleneck. Embodiments described herein provide an innovative process that brings less copper to the second platen to provide much higher throughput with a shorter polish time on the second platen while at the same time providing equivalent or superior topography results in comparison with traditional methods. Emobidments described herein are also compatible with a single platen copper clear process in which high throughput and low topography is desirable.

Embodiments described herein will be described below in reference to a planarizing process and composition that can be carried out using chemical mechanical polishing process equipment, such as MIRRA™, MIRRA MESA™, REFLEXION™, REFLEXION LK™, and REFLEXION LK ECMP™ chemical mechanical planarizing systems, available from Applied Materials, Inc. of Santa Clara, Calif. Other planarizing modules, including those that use processing pads, planarizing webs, or a combination thereof, and those that move a substrate relative to a planarizing surface in a rotational, linear, or other planar motion may also be adapted to benefit from the embodiments described herein. In addition, any system enabling chemical mechanical polishing using the methods or compositions described herein can be used to advantage. The following apparatus description is illustrative and should not be construed or interpreted as limiting the scope of the embodiments described herein.

### Apparatus

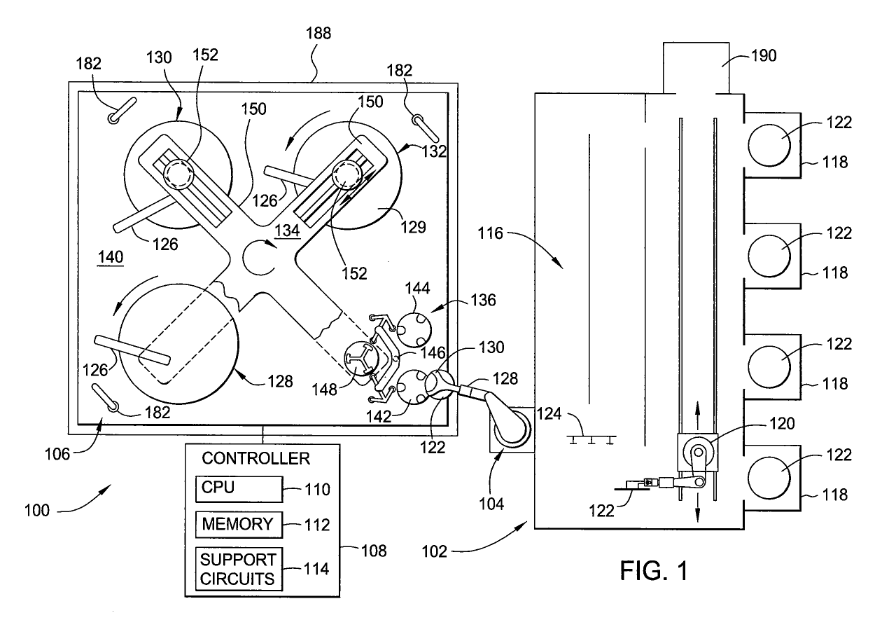

FIG. 1 is a plan view of one embodiment of a planarization system 100 having an apparatus for chemical mechanical processing of a substrate. The system 100 generally comprises a factory interface 102, a loading robot 104, and a planarizing module 106. The loading robot 104 is disposed to facilitate the transfer of substrates 122 between the factory interface 102 and the planarizing module 106.

A controller 108 is provided to facilitate control and integration of the modules of the system 100. The controller 108 comprises a central processing unit (CPU) 110, a memory 112, and support circuits 114. The controller 108 is coupled to the various components of the system 100 to facilitate control of the planarizing, cleaning, and transfer processes.

The factory interface 102 generally includes a metrology module 190, a cleaning module 116 and one or more substrate cassettes 118. An interface robot 120 is employed to transfer substrates 122 between the substrate cassettes 118, the cleaning module 116, and an input module 124. The input module 124 is positioned to facilitate transfer of substrates 122 between the planarizing module 106 and the factory interface 102 by grippers, for example, vacuum grippers or mechanical clamps.

The metrology module 190 may be a non-destructive measuring device suitable for providing a metric indicative of the thickness profile of a substrate. The metrology module 190 may include eddy current sensors, an interferometer, a capacitance sensor and other suitable devices. Examples of suitable metrology modules include ISCAN™ and IMAP™ substrate metrology modules, available from Applied Materials, Inc. The metrology module 190 provides the metric to the controller 108 wherein a target removal profile is determined for the specific thickness profile measured from the substrate.

The planarizing module 106 includes at least a first chemical mechanical planarizing (CMP) station 128, disposed in an environmentally controlled enclosure 188. In the embodiment depicted in FIG. 1, the planarizing module 106 includes the first CMP station 128, a second CMP station 130 and a third CMP station 132. Bulk removal of conductive material disposed on the substrate 122 may be performed through a chemical mechanical polishing process at the first CMP station 128. In one embodiment, the bulk removal of conductive material may be a multi-step process. After the bulk material removal at the first CMP station 128, the remaining conductive material or residual conductive material may be cleared from the substrate at the second CMP station 130 in a single-step or multi-step chemical mechanical polishing process, wherein part of the multi-step process is configured to remove residual conductive material. The third CMP station 132 may be used to polish a barrier layer. In one embodiment, both the bulk material removal and residual material removal may be performed at a single station. Alternatively, more than one CMP station may be utilized to perform the multi-step removal process after the bulk removal process performed at a different station.

The exemplary planarizing module 106 also includes a transfer station 136 and a carousel 134 that are disposed on an upper or first side of a machine base 140. In one embodiment, the transfer station 136 includes an input buffer station 142, an output buffer station 144, a transfer robot 146, and a load cup assembly 148. The input buffer station 142 receives substrates from the factory interface 102 by means of the loading robot 104. The loading robot 104 is also utilized to return polished substrates from the output buffer station 144 to the factory interface 102. The transfer robot 146 is utilized to move substrates between the buffer stations 142, 144 and the load cup assembly 148.

In one embodiment, the transfer robot 146 includes two gripper assemblies, each having pneumatic gripper fingers that hold the substrate by the substrate's edge. The transfer robot 146 may simultaneously transfer a substrate to be processed from the input buffer station 142 to the load cup assembly 148 while transferring a processed substrate from the load cup assembly 148 to the output buffer station 144.

The carousel 134 is centrally disposed over the base 140. The carousel 134 typically includes a plurality of arms 150, each supporting a carrier head assembly 152. Two of the arms 150 depicted in FIG. 1 are shown in phantom such that the transfer station 136 and a planarizing surface 129 of the first CMP station 128 may be seen. The carousel 134 is indexable such that the carrier head assemblies 152 may be moved between the planarizing stations 128, 130, and 132 and the transfer station 136. A conditioning device 182 is disposed on the base 140 adjacent each of the planarizing stations 128, 130, and 132. The conditioning device 182 periodically conditions the planarizing material disposed in the stations 128, 130, and 132 to maintain uniform planarizing results.

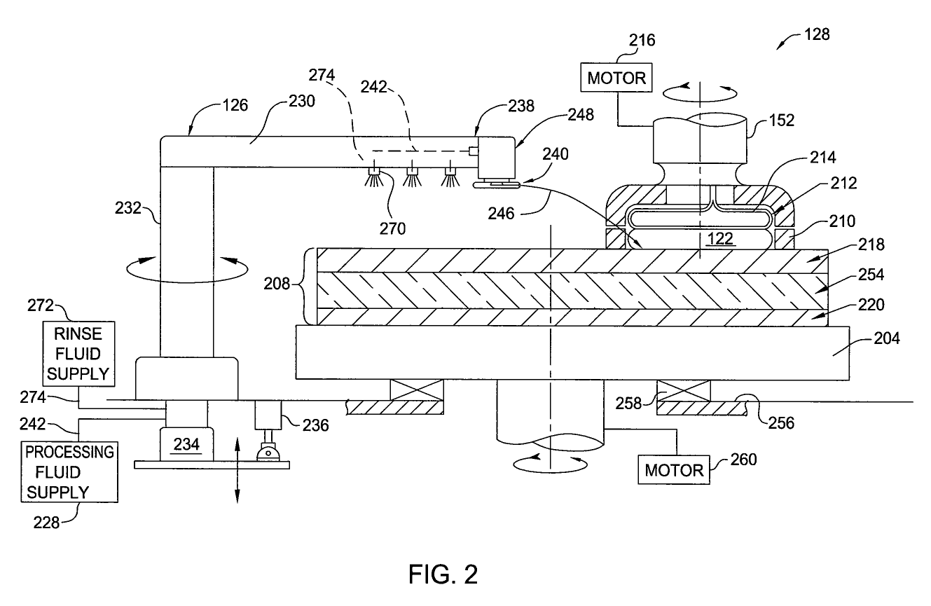

FIG. 2 is a partial sectional view of one embodiment of the first CMP station 128 that includes the fluid delivery arm assembly 126. Referring to FIG. 1, the first CMP processing station 128 includes the carrier head assembly 152 and a platen 204. The carrier head assembly 152 generally retains the substrate 122 against a polishing pad 208 disposed on the platen 204. At least one of a carrier head assembly 152 or platen 204 is rotated or otherwise moved to provide relative motion between the substrate 122 and the polishing pad 208. In the embodiment depicted in FIG. 2, the carrier head assembly 152 is coupled to an actuator or motor 216 that provides at least rotational motion to the substrate 122. The motor 216 may also oscillate the carrier head assembly 152, such that the substrate 122 is moved laterally back and forth across the surface of the polishing pad 208.

The polishing pad 208 may comprise a conventional material such as a foamed polymer disposed on the platen 204 as a pad. In one embodiment, the conventional polishing material 208 is foamed polyurethane. In one embodiment, the pad is an IC1010 polyurethane pad, available from Rodel Inc., of Newark, Del. IC1010 polyurethane pads typically have a thickness of about 2.05 mm and a compressability of about 2.01%. Other pads that can be used include IC1000 pads with and without an additional compressible bottom layer underneath the IC1000 pad, IC1010 pads with an additional compressible bottom layer underneath the IC1010 pad, and polishing pads available from other manufacturers. The compositions described herein are placed on the pad to contribute to the chemical mechanical polishing of substrate.

In one embodiment, the carrier head assembly 152 includes a retaining ring 210 circumscribing a substrate receiving pocket 212. A bladder 214 is disposed in the substrate receiving pocket 212 and may be evacuated to chuck the wafer to the carrier head assembly 152 and pressurized to control the downward force of the substrate 122 when pressed against the polishing pad 208. In one embodiment, the carrier head may be a multi-zone carrier head. One suitable carrier head assembly 152 is a TITAN HEAD™ carrier head available from Applied Materials, Inc., located in Santa Clara, Calif. Other examples of carrier heads that may be adapted to benefit from the embodiments described herein are described in U.S. Pat. No. 6,159,079, issued Dec. 12, 2001, and U.S. Pat. No. 6,764,389, issued Jul. 29, 2004, which are incorporated herein by reference in their entirety.

In FIG. 2, the platen 204 is supported on a base 256 by bearings 258 that facilitate rotation of the platen 204. A motor 160 is coupled to the platen 204 and rotates the platen 204 such that the pad 208 is moved relative to the carrier head assembly 152.

In the embodiment depicted in FIG. 1, the polishing pad 208 includes an upper layer 218 and an underlying layer 220. Optionally, one or more intervening layers 254 may be disposed between the underlying layer 220 and upper layer 218. For example, the intervening layers 254 may include at least one of a subpad and an interposed pad. In one embodiment, the subpad may be a urethane-based material, such as a foam urethane. In one embodiment, the interposed pad may be a sheet of Mylar.

The fluid delivery arm assembly 126 is utilized to deliver a processing fluid from a processing fluid supply 228 to a top or working surface of the upper layer 218. In the embodiment depicted in FIG. 2, the fluid delivery arm assembly 126 includes an arm 230 extending from a stanchion 232. A motor 234 is provided to control the rotation of the arm 230 about a center line of the stanchion 232. An adjustment mechanism 236 may be provided to control the elevation of a distal end 238 of the arm 230 relative to the working surface of the pad 208. The adjustment mechanism 236 may be an actuator coupled to at least one of the arm 230 or the stanchion 232 for controlling the elevation of the distal end 238 of the arm 230 relative to the platen 204. Some examples of suitable fluid delivery arms which may be adapted to benefit from the embodiments described herein are described in U.S. patent application Ser. No. 11/298,643, filed Dec. 8, 2005, entitled METHOD AND APPARATUS FOR PLANARIZING A SUBSTRATE WITH LOW FLUID CONSUMPTION; now published as US 2007/0131562, U.S. patent application Ser. No. 09/921,588, entitled MULTIPORT POLISHING FLUID DELIVERY SYSTEM, filed Aug. 2, 2001, now published as US 2003/0027505; U.S. patent application Ser. No. 10/428,914, entitled SLURRY DELIVERY ARM, filed May 2, 2003, now issued as U.S. Pat. No. 6,939,210; U.S. patent application Ser. No. 10/131,638, entitled FLEXIBLE POLISHING FLUID DELVERY SYSTEM, filed Apr. 22, 2002, now issued as U.S. Pat. No. 7,086,933, which are all hereby incorporated by reference in their entirety to the extent not inconsistent with this application.

The fluid delivery arm assembly 126 may include a plurality of rinse outlet ports 270 arranged to uniformly deliver a spray and/or stream of rinsing fluid to the surface of the pad 208. The ports 270 are coupled by a tube 274 routed through the fluid delivery arm assembly 126 to a rinsing fluid supply 272. In one embodiment, the fluid delivery arm may have between 12 and 15 ports. The rinsing fluid supply 272 provides a rinsing fluid, such as deionized water, to the pad 208 during the polishing process and/or after the substrate 122 is removed to clean the pad 208. The pad 208 may also be cleaned using fluid from the ports 270 after conditioning the pad using a conditioning element, such as a diamond disk or brush (not shown).

The nozzle assembly 248 is disposed at the distal end of the arm 230. The nozzle assembly 248 is coupled to the fluid supply 228 by a tube 242 routed through the fluid delivery arm assembly 226. The nozzle assembly 248 includes a nozzle 240 that may be selectively adjusted relative to the arm, such that the fluid exiting the nozzle 240 may be selectively directed to a specific area of the pad 208.

In one embodiment, the nozzle 240 is configured to generate a spray of processing fluid. In another embodiment, the nozzle 240 is adapted to provide a stream of processing fluid. In another embodiment, the nozzle 240 is configured to provide a stream and/or spray of processing fluid 246 at a rate between about 20 to about 120 cm/second to the polishing surface.

### Method

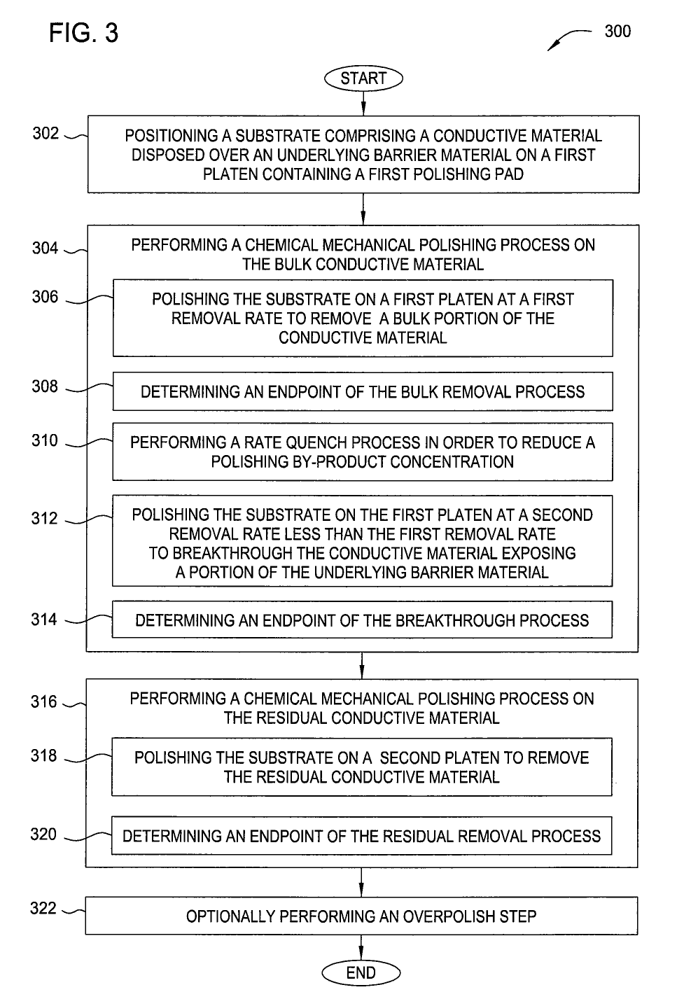

FIG. 3 depicts one embodiment of a method 300 for chemical mechanical polishing a substrate having an exposed conductive material layer and an underlying barrier layer that may be practiced on the system 100 described above. The method 300 may also be practiced on other chemical mechanical processing systems. The method 300 is generally stored in the memory 112 of the controller 108, typically as a software routine. The software routine may also be stored and/or executed by a second CPU (not shown) that is remotely located from the hardware being controlled by the CPU 110.

Although embodiments described herein are discussed as being implemented as a software routine, some of the method steps that are disclosed herein may be performed in hardware as well as by the software controller. As such, the embodiments described herein may be implemented in software as executed upon a computer system, in hardware as an application specific integrated circuit or other type of hardware implementation, or a combination of software and hardware.

The method 300 begins at step 302 by positioning a substrate comprising a conductive material disposed over an underlying barrier material on a first platen containing a first polishing pad. The conductive layer may comprise tungsten, copper, combinations thereof, and the like. The barrier layer may comprise ruthenium, tantalum, tantalum nitride, titanium, titanium nitride, tungsten nitride, tungsten, combinations thereof, and the like. A dielectric layer, typically an oxide, generally underlies the barrier layer.

In one embodiment, the substrate 122 retained in the carrier head assembly 152 is moved over the polishing pad 208 disposed in the first CMP station 128. The carrier head assembly 152 is lowered toward the polishing pad 208 to place the substrate 122 in contact with the top surface of the polishing pad assembly 208.

At step 304 a chemical mechanical polishing process is performed on the bulk conductive material. At step 306, the substrate is polished on a first platen at a first removal rate to remove a bulk portion of the conductive material. In one embodiment, the conductive layer is a copper layer having an initial thickness between about 6000-8000 Å. In one embodiment, the polishing step 306 may be performed at the first CMP station 128. The substrate 122 may be urged against the polishing pad 208 with a force of less than about 2.5 pounds per square inch (psi). In one embodiment, the force is between about 1 psi and 2 psi, for example, about 1.8 psi.

Next, relative motion between the substrate 122 and polishing pad 208 is provided. In one embodiment, the carrier head assembly 152 is rotated at between about 50-100 revolutions per minute, for example, between about 30-60 revolutions per minute, while the polishing pad 208 is rotated at between about 50-100 revolutions per minute, for example, between about 7-35 revolutions per minute. The process generally has a copper removal rate of about 9000 Å/min.

A polishing slurry is supplied to the polishing pad 208. In certain embodiments, the polishing slurry may comprise an oxidizer such as hydrogen peroxide, a passivation agent such as a corrosion inhibitor, a pH buffer, a metal complexing agent, abrasives, and combinations thereof. Suitable corrosion inhibitors include compounds having a nitrogen atom (N), such as organic compounds having an azole group. Examples of suitable compounds include benzotriazole (BTA), mercaptobenzotriazole, 5-methyl-1-benzotriazole (TTA), derivatives thereof, and combinations thereof. Other suitable corrosion inhibitors include film forming agents such as, imidazole, benzimidazole, triazole, and combinations thereof. Derivatives of benzotriazole, imidazole, benzimidazole, triazole, with hydroxy, amino, imino, carboxy, mercapto, nitro and alkyl substituted groups may also be used as corrosion inhibitors. The polishing slurry may typically include a corrosion inhibitor such as (BTA).

In certain embodiments, the polishing slurry also contains abrasives such as colloidal silica, alumina, and/or cerria. In certain embodiments, the polishing slurry may additionally comprise surfactants. Examples of suitable polishing compositions and methods for bulk chemical mechanical processes are described in U.S. patent application Ser. No. 11/839,048, entitled IMPROVED SELECTIVE CHEMISTRY FOR FIXED ABRASIVE CMP, filed Aug. 15, 2007, now published as US 2008/0182413 and U.S. patent application Ser. No. 11/356,352, entitled METHOD AND COMPOSITION FOR POLISHING A SUBSTRATE, now published as US2006/0169597, both of which are herein incorporated by reference to the extent not inconsistent with the current application. In certain embodiments, the substrate 122 contacts the polishing pad 208 after addition of the polishing slurry. In certain embodiments, the substrate 122 contacts the polishing pad 208 prior to the addition of the polishing slurry.

At step 308, an endpoint of the bulk portion removal process is determined. In one embodiment, the endpoint of the bulk portion removal process occurs prior to breakthrough of the copper layer. The endpoint may be detected using detection systems such as the iScan™ thickness monitor and the FullScan™ optical endpoint system, both of which are available from Applied Materials, Inc. of Santa Clara, Calif.

An endpoint of the process may also be determined using real time profile control (RTPC). For example, in a CMP process, the thickness of the conductive material at different regions on the substrate may be monitored and detected non-uniformities may cause the CMP system to adjust polishing parameters in real time. RTPC may be used to control the remaining copper profile by adjusting zone pressures in the carrier polishing head. Examples of suitable RTPC techniques and apparatus are described in U.S. Pat. No. 7,229,340, to Hanawa et al. entitled METHOD AND APPARATUS FOR MONITORING A METAL LAYER DURING CHEMICAL MECHANICAL POLISHING and U.S. patent application Ser. No. 10/633,276, entitled EDDY CURRENT SYSTEM FOR IN-SITU PROFILE MEASUREMENT, filed Jul. 31, 2003, now issued as U.S. Pat. No. 7,112,960, all of which are hereby incorporated by reference in their entirety.

In one embodiment the endpoint may be determined using spectrum based endpoint detecting techniques. Spectrum based endpoint techniques include obtaining spectra from different zones on a substrate during different times in a polishing sequence, matching the spectra with indexes in a library and using the indexes to determine a polishing rate for each of the different zones from the indexes. In another embodiment, the endpoint may be determined using a first metric of processing provided by a meter. The meter may provide charge, voltage or current information utilized to determine the remaining thickness of the conductive material (e.g., the copper layer) on the substrate. In another embodiment, optical techniques, such as an interferometer utilizing a sensor may be utilized. The remaining thickness may be directly measured or calculated by subtracting the amount of material removed from a predetermined starting film thickness. In one embodiment, the endpoint is determined by comparing the charge removed from the substrate to a target charge amount for a predetermined area of the substrate. Examples of endpoint techniques that may be utilized are described in U.S. Pat. No. 7,226,339, entitled SPECTRUM BASED ENDPOINTING FOR CHEMICAL MECHANICAL POLISHING, issued Jun. 5, 2007 to Benvegnu et al., U.S. patent application Ser. No. 11/748,825, entitled SUBSTRATE THICKNESS MEASURING DURING POLISHING, filed May 15, 2007, now published as US 2007/0224915, and U.S. Pat. No. 6,924,641, to Hanawa et al., entitled METHOD AND APPARATUS FOR MONITORING A METAL LAYER DURING CHEMICAL MECHANICAL POLISHING, all of which are hereby incorporated by reference in their entireties.

In one embodiment, the remaining copper layer has a thickness between about 1400 Å to about 2000 Å. In one embodiment, the first endpoint occurs when the conductive layer has a thickness of about 2000 Å.

At step 310, a rate quench process to reduce the concentration of polishing by-products, such as metal ions, is performed. A slightly center thin to edge thick profile is desirable after removal of the first portion of the bulk conductive material. However, after removal of the first portion of the bulk conductive material, the concentration of polishing by-products, such as copper ions, on the polishing pad 208 and in the polishing slurry is generally very high. This high concentration of metal ions in the polishing slurry consumes the passivation agent thus reducing the amount of passivation agent available to passivate and protect the copper lines and topography. As a result, this high concentration of metal ions must be reduced prior to copper breakthrough which occurs with approximately 1400 Å of copper remaining.

The rate quench process may comprise adding a rinsing agent to the polishing slurry to dilute the concentration of polishing by-products in the polishing slurry, increasing the flow rate of the polishing slurry, rinsing the polishing pad, and combinations thereof.

In one embodiment, the rate quench process may be accomplished by adding a rinsing agent to the polishing slurry to dilute the concentration of metal ions in the polishing slurry. In one embodiment, the rinsing agent may be delivered to the polishing slurry using the fluid delivery arm assembly 126 or distributed slurry dispense arm (DSDA) located adjacent to the first CMP station 128. In one embodiment, the rinsing agent comprises distilled water (DIW). In one embodiment the flow rate of the rinsing agent may be between about 300 ml/min and about 1000 ml/min, for example, about 500 ml/min.

In one embodiment, the rate quench process may comprise increasing the flow rate of the polishing slurry. In one embodiment the flow rate of the polishing slurry may be between about 300 ml/min and about 500 ml/min.

In one embodiment, the rate quench process may comprise rinsing the polishing pad 208 with the rinsing agent in order to reduce the copper ion concentration on the polishing pad 208.

The fluid delivery arm assembly 126 or distributed slurry dispense arm (DSDA) located adjacent to the first CMP station 128 may be used to perform the rate quench step. The rate quench step may be performed after the substrate is polished on the first platen to remove a first portion of the bulk conductive material and prior to or during the soft landing step 312. Copper inhibitor additives present in the slurry passivate the conductive layer or copper but the copper inhibitor is also consumed by copper ions. If the concentration of copper ions is high then copper inhibitor concentration will be low and coverage of the wafer will be poor leading to poor copper passivation and high topography at copper breakthrough. The fluid delivery arm assembly 126 promotes good copper inhibitor coverage of the wafer during the soft landing step 308 to copper breakthrough and also more effectively dilutes the copper ion concentration.

During the rate quench process, the polishing down force may be reduced to about 0.5 psi. The reduced polishing down force is applied so that copper inhibitor from the polishing slurry more efficiently contacts the substrate and also helps remove polishing by-products from the substrate surface.

At step 312, a “soft landing” polishing step is performed where the substrate is polished on the first platen at a second removal rate less than the first removal rate to breakthrough the conductive material and expose a portion of the underlying barrier material. The soft landing step step 312 requires a low copper removal rate. In one embodiment, during the soft landing step, the substrate may be polished at a removal rate between about 1500-2500 Å/min, for example, about 1800 Å/min. In one embodiment, the substrate 122 may be urged against the polishing pad 208 with a down force between about 1.0 psi and 1.6 psi, for example, about 1.3 psi. In one embodiment the flow rate of the polishing slurry may be between about 200 ml/min and about 500 ml/min, for example, between about 250 ml/min and about 350 ml/min.

Uniform slurry distribution provided by the fluid delivery arm assembly 126 ensures that the copper ion concentration is low and provides a larger process window. During the soft landing step 312, first breakthrough at the substrate center is desired as the center of the substrate has a larger overpolish window. It is believed that the concentration of polishing by-products, such as copper ions, being removed from the substrate and off of the pad have a higher concentration at the edge of the substrate than at the center of the substrate. Thus, the copper inhibitor residence time at the center of the substrate is longer leading to better passivation. The final endpoint for the bulk conductive material removal process at the first CMP station 128 is at first copper breakthrough. With the copper already broken through, polishing time to remove the remaining conductive layer on the second CMP station 130 is reduced leading to higher wafer throughput. Lower topography also results with less copper material coming to the second CMP station 130 during copper final clearing and field copper residue removal. With less copper to remove on the second platen, the copper ion concentration will be lower. With fewer copper ions, copper inhibitor will be consumed at a lower rate leading to higher copper inhibitor concentrations. With higher copper inhibitor concentrations greater copper inhibitor passivation of the substrate will result leading to lower topography. With less copper ions generated on the second CMP station 130, higher than expected down forces can be used without negatively impacting topography which improves the ability to fully remove field copper residue.

At step 314, an endpoint of the breakthrough process is determined. The second endpoint may be determined using FulIScan™ and the other endpoint techniques described herein.

At step 316, a chemical mechanical polishing process is performed on the residual conductive material. The residual conductive material removal process comprises polishing the substrate on a second platen and determining an endpoint of that polishing process. At step 318, the substrate is polished on a second platen to remove any residual conductive material. In one embodiment, the substrate may be polished at a removal rate between about 1500-2500 Å/min, for example, about 2400 Å/min. Step 318 may be a single or multi-step chemical mechanical clearance process. The clearance step 318 may be performed on the second CMP station 130, or one of the other CMP stations 128, 132.

The clearance processing step 318 begins by moving the substrate 122 retained in the carrier head assembly 152 over the polishing pad disposed in the second CMP station 130. The carrier head assembly 152 is lowered toward the polishing pad to place the substrate 122 in contact with the top surface of the polishing pad. The substrate 122 is urged against the polishing pad with a force less than about 2 psi. In another embodiment, the force is less than or equal to about 0.3 psi.

Next, relative motion between the substrate 122 and polishing pad is provided. Polishing slurry is supplied to the polishing pad. In one embodiment, the carrier head assembly 152 is rotated at about 30-80 revolutions per minute, for example, about 50 rpms, while the polishing pad is rotated at about 7-90 revolutions per minute, for example, about 53 rpm. The process of step 318 generally has a removal rate of about 1500 Å/min for tungsten and about 2000 Å/min for copper.

At step 320 an endpoint of the residual conductive material removal is determined. The endpoint may be determined using FullScan™ or any of the other techniques discussed above. In one embodiment, for an electrochemical mechanical polishing process (Ecmp), the endpoint is determined by detecting a first discontinuity in current sensed by using a meter. The discontinuity appears when the underlying layer begins to break through the conductive layer (e.g., the copper layer). As the underlying layer has a different resistivity than the copper layer, the resistance across the processing cell (i.e., from the conductive portion of the substrate to the electrode) changes as the area of conductive layer relative to the exposed area of the underlying layer changes, thereby causing a change in the current.

Optionally, in response to the endpoint detection, a second clearance process step may be performed to remove the residual copper layer. The substrate is pressed against the pad assembly with a pressure less than about 2 psi, and in another embodiment, substrate is pressed against the pad assembly with a pressure less than or equal to about 0.3 psi. The process of step generally has a removal rate of about 500 to about 2000 Å/min, for example, between about 500 to about 1200 Å/min for both copper and tungsten processes.

Optionally, at step 322, a third clearance process step or “overpolish” may be performed to remove any remaining debris from the conductive layer. The third clearance process step is typically a timed process, and is performed at a reduced pressure. In one embodiment, the third clearance process step (also referred to as an overpolish step) has a duration of about 10 to about 30 seconds.

Following the residual conductive material removal step 316, a barrier polish may be performed. In one embodiment, the barrier polish may be performed on the third CMP station 132, but may alternatively be performed one of the other CMP stations 128, 130.

In another embodiment, this process may be adapted for a one platen copper clear process. The process may be applied as a 2 step process with a copper ion quench step in between. RTPC for good copper remaining profile may be used along with DSDA to ensure good copper inhibitor coverage across the wafer to help reduce the copper removal rate by more effectively diluting copper ions providing good copper passivation across the wafer leading to good topography. It is important to control the balance of copper ions and copper inhibitor concentration during copper breakthrough and clearing.

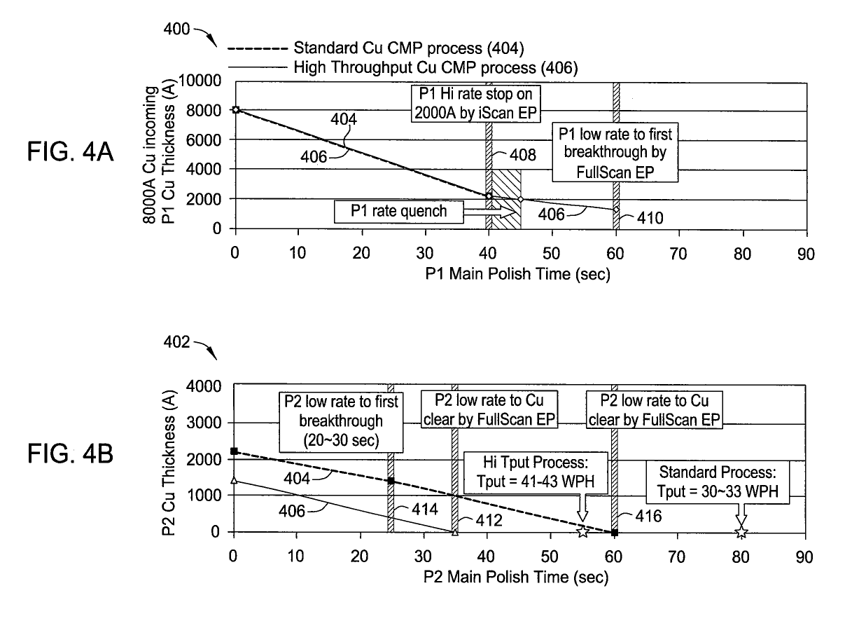

FIG. 4A is a plot 400 depicting the thickness of a copper layer (Å) on the y-axis versus the polish time (seconds) on the x-axis for platen 1 and FIG. 4B is a plot 402 depicting the thickness of a copper layer (Å) on the y-axis versus the polish time (seconds) on the axis for platen 2. Line 404 represents the copper removal rate for the standard copper CMP process performed on a substrate with an incoming copper layer thickness of about 8000 Å and Line 406 represents the copper removal rate for a high throughput CMP process performed on a substrate with an incoming copper layer thickness of 8000 Å using embodiments described herein.

The substrates were polished on a first platen at a high removal rate of about 9000 ÅA/min until reaching a first endpoint 408. The first endpoint 408 was detected using RTPC. At the first endpoint 408 a rate quench process lasting approximately 5 seconds was performed during the high throughput copper CMP process to reduce the concentration of copper ions on the polishing pad. During the rate quench process, conductive material was removed at a reduced removal rate of about 1200 Å/min. After the rate quench process, the substrate polished using the high throughput copper CMP process was exposed to a “soft landing step.” During the soft landing step the substrate was polished at a low removal rate of about 2400 Å/min until first copper breakthrough to expose a barrier layer at a second endpoint 410. The second endpoint was detected using the FullScan™ optical endpoint detection system. At the second endpoint 410, the substrate polished using the high throughput copper CMP process was transferred to the second platen where the residual copper was polished at a removal rate of about 2400 Å/min until reaching a final endpoint 412 where the residual copper has been cleared. The final endpoint was detected using the FullScan™ optical endpoint detection system. A 20 second overpolish process was performed. The high throughput copper CMP process achieved a throughput of 41 to 43 wafers per hour (WPH) for an incoming copper thickness of 8000 Å/min.

The substrates polished using the standard copper CMP process were polished on a first platen at a high rate of about 9000 Å/min until reaching a first endpoint 408 at approximately 2000 Å of copper. The first endpoint 408 was detected using RTPC. At the first endpoint 408 the substrate polished using the standard copper CMP process was transferred to a second platen for removal of the residual copper layer. The residual copper layer was removed at a rate of about 2000 Å/min until reaching a first copper breakthrough endpoint 414. At the first copper breakthrough endpoint the residual copper material was cleared at a removal rate of about 2000 Å/min until reaching the final endpoint 416. The final endpoint was detected using the FullScan™ optical endpoint detection system. A 20 second overpolish process was performed. The standard copper CMP process achieved a throughput of 30-33 WPH.

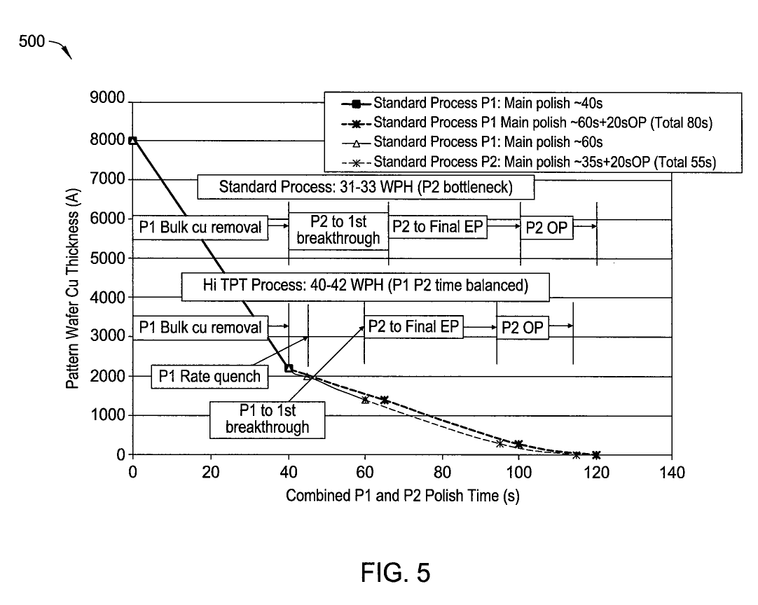

FIG. 5 is plot 500 comparing the polish time for standard and high throughput copper processes. The y-axis represents copper thickness (Å) and the x-axis represents the combined polish times on the first platen and the second platen. As shown in FIG. 5, for the standard process, the substrate polish time on the first platen is approximately 40 seconds and the standard process time for the second platen is approximately 80 seconds. Due to the longer polish time on the second platen, a bottleneck is experienced on the second platen. As shown in FIG. 5, for the high throughput copper process, the substrate polish time on the first platen is approximately 60 seconds and the substrate polish time on the second platen is approximately 55 seconds. The more balanced polish times for the first platen and the second platen eliminate the bottleneck experienced at the second platen yielding a higher wafer throughput of 40-42 WPH.

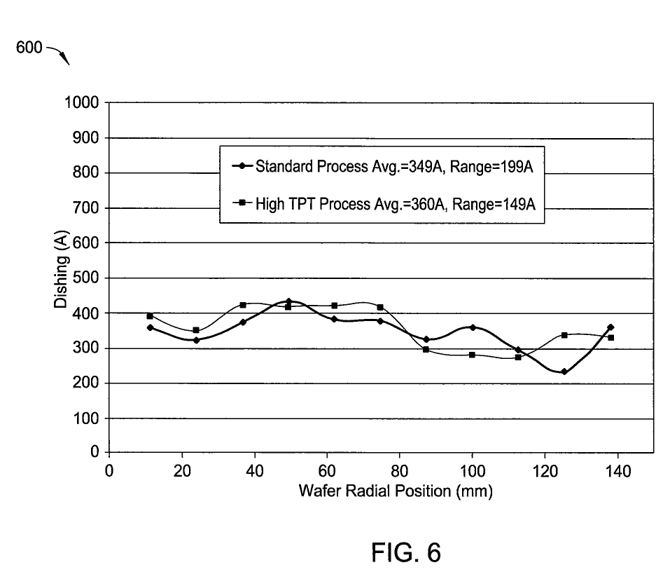

FIG. 6 is a plot 600 comparing the topography performance for the standard and high throughput copper processes. The y-axis represents dishing (Å) and the x-axis represents the radial position (mm) on the substrate. The results demonstrate comparable topography performance within 50 Å for the standard process and the high throughput process.

Embodiments described herein advantageously provide improved methods and apparatus for chemical mechanical processing of metal and barrier materials which increases substrate throughput while maintaining improved planarization efficiency. On platen 1, bulk copper may be removed to approximately 2000 Å remaining with no breakthrough at a high rate of greater than 9000 A/min at a pressure of 1.8 psi. Real time process control (RTPC) may be used to control the copper remaining profile by adjusting zone pressures in the carrier polishing head to achieve a center thin to edge thick profile which is desired after bulk copper removal. After the bulk copper removal step the concentration of copper ions on the pad is very high and must be diluted in order to proceed to the second step leading to copper breakthrough which occurs with approximately 1400 Å of copper remaining. A rate quench step is used to reduce the concentration of copper ions. This rate quench step is accomplished by flowing DIW and/or by increasing slurry flow rate.

A distributed slurry dispense arm (DSDA) may be used on platen 1 mainly due to this rate quench step and the soft landing step to breakthrough. Copper inhibitor additives in the slurry passivate the copper but the copper inhibitor is consumed by copper ions. If the concentration of copper ions is high then copper inhibitor concentration will be low and coverage of the wafer will be poor leading to high topography at copper breakthrough. The DSDA promotes good copper inhibitor coverage of the wafer during the second step to copper breakthrough and also helps to more effectively dilute copper ion concentration. The second step requires a low copper removal rate to ensure copper ion concentration is low and the uniform slurry distribution through the DSDA arm provides a large process window. Wafer center first breakthrough is desirable as the center of the wafer has a larger overpolish window. The copper inhibitor residence time in the center of the wafer is longer leading to better passivation. It is believed that the concentration of polishing by-products, such as copper ions, being removed from the substrate and off of the pad have a higher concentration at the edge of the substrate than at the center of the substrate. The final endpoint on platen 1 is at first breakthrough.

With copper already broken through, polishing time on the second platen will be shorter leading to higher throughput. Lower topography also results with less copper coming to platen 2 during copper final clearing and field copper residue removal. With less copper removed, copper ion concentration will be lower. With less copper ions, copper inhibitor will not be consumed as much leading to higher copper inhibitor concentrations. With higher copper inhibitor concentrations greater copper inhibitor passivation of the wafer will result leading to lower topography. With less copper ions generated on platen 2, higher than expected down forces can be used without negatively impacting topography which improves ability to fully remove field copper residue.

While the foregoing is directed to embodiments of the present invention, other and further embodiments of the invention may be devised without departing from the basic scope thereof, and the scope thereof is determined by the claims that follow.

1. A method for chemical mechanical polishing (CMP) of a conductive material disposed on a substrate, comprising:
positioning a substrate comprising a conductive material disposed over an underlying barrier material on a first platen containing a first polishing pad in a polishing slurry;
polishing the substrate on the first platen to remove a bulk portion of the conductive material;
performing a rate quench process to reduce a metal ion concentration in the polishing slurry; and
polishing the substrate on the first platen to breakthrough the conductive material and expose a portion of the underlying barrier material.

2. The method of claim 1, further comprising:
polishing the substrate on a second platen to clear conductive material from the barrier material.

3. The method of claim 1, wherein the rate quench process comprises increasing the concentration of a corrosion inhibitor in the polishing slurry.

4. The method of claim 1, wherein the rate quench process comprises increasing the flow rate of the polishing slurry.

5. The method of claim 4, wherein the increasing the flow rate of the polishing slurry comprises increasing the slurry flow rate to between about 300 mL/min and about 500 mL/min.

6. The method of claim 1, wherein the rate quench process comprises rinsing the polishing pad with deionized water.

7. The method of claim 1, wherein the performing a rate quench process to reduce a metal ion concentration in the polishing slurry and the polishing the substrate on the first platen to breakthrough the conductive material and expose a portion of the underlying barrier material occur simultaneously.

8. A method for chemical mechanical polishing (CMP) of a conductive material disposed on a substrate, comprising:
positioning a substrate comprising a conductive material disposed over an underlying barrier material on a first platen containing a first polishing pad in a polishing slurry;
polishing the substrate on a first platen to remove a bulk portion of the conductive material;
determining an endpoint for the polishing the substrate on a first platen to remove a bulk portion of the conductive material;
performing a rate quench process in order to reduce a metal ion concentration in the polishing slurry;
polishing the substrate on the first platen to breakthrough the conductive material and expose a portion of the underlying barrier material.

9. The method of claim 8, further comprising:
determining an endpoint for the polishing the substrate on the first platen to breakthrough the conductive material and expose a portion of the underlying barrier material.

10. The method of claim 9, further comprising:
polishing the substrate on a second platen to clear conductive material from the barrier material.

11. The method of claim 8, wherein the rate quench process comprises increasing the concentration of a corrosion inhibitor in the polishing slurry.

12. The method of claim 8, wherein the rate quench process comprises increasing the flow of the polishing slurry.

13. The method of claim 12, wherein the increasing the flow of the polishing slurry comprises increasing the slurry flow rate to between about 300 mL/min and about 500 mL/min.

14. The method of claim 8, wherein the rate quench process comprises rinsing the polishing pad with deionized water.

15. The method of claim 8, wherein the performing a rate quench process to reduce a metal ion concentration in the polishing slurry and the polishing the substrate on the first platen to breakthrough the conductive material and expose a portion of the underlying barrier material occur simultaneously.

16. A method for chemical mechanical polishing (CMP) of a conductive material disposed on a substrate, comprising:
positioning a substrate comprising copper material disposed over an underlying barrier material on a platen containing a polishing pad in a polishing composition comprising a corrosion inhibitor;
contacting the substrate with the polishing pad;
polishing the substrate with the polishing pad to remove bulk copper material;
detecting a first endpoint of the bulk copper material removal;
rinsing the polishing pad with a rinse solution;
polishing the substrate with the polishing pad to breakthrough the copper material and expose a portion of the underlying barrier material; and
polishing the substrate to remove residual copper material.

17. The method of claim 16, wherein polishing the substrate to breakthrough the copper material and expose the underlying barrier material comprises detecting a second endpoint when the copper material is first broken through.

18. The method of claim 16, wherein the corrosion inhibitor comprises benzotriazole (BTA).

19. The method of claim 17, wherein the polishing the substrate to remove residual copper material is performed on a second platen.

20. The method of claim 16, wherein the rinsing the polishing pad with a rinse solution reduces a copper ion concentration on the polishing pad.
